(19) United States
(12) Patent Application Publication
(10) Pub. No.: US 2008/0179414 A1
(43) Pub. Date: Jul. 31, 2008

(54) HEATING DEVICE FOR HEATING A STORAGE DEVICE FOR A COMPLEX SALT AND METHOD AND DEVICE FOR OPERATING THE HEATING DEVICE

(76) Inventors: Rainer Bentz, Wendel (DE); Joachim Frank, Coburg (DE)

Correspondence Address: Rainer Bentz, Auf der Hell 22, 66606 St. Wendel, omitted

(21) Appl. No.: 12/020,824

(22) Filed: Jan. 28, 2008

(30) Foreign Application Priority Data
Jan. 30, 2007 (DE) 10 2007 004 602.4

(51) Int. Cl. B60H 1/02

(52) U.S. Cl. 237/12.3 R; 237/12.3 C; 237/12.3 B; 237/12; 237/2 A

(57) ABSTRACT

A heating device for heating a storage device (2) for a complex salt in a motor vehicle includes the storage device (2) for the complex salt and at least one mass-ducting hollow pipe (4). A mass flows through the mass-ducting hollow pipe (4) while the motor vehicle is operating and heats up while the motor vehicle is operating, and is thermally coupled to the storage device (2) for the complex salt in such a way that the heated mass in the mass-ducting hollow pipe (4) will heat the storage device (2) for the complex salt.

### CROSS-REFERENCE TO RELATED APPLICATIONS

This application claims priority to German Patent Application Number 10 2007 004 602.4 filed on Jan. 30, 2007, and which is incorporated herein by reference in its entirety.

### TECHNICAL FIELD

The invention relates to a heating device for heating a storage device for a complex salt in a motor vehicle. The heating device includes the storage device for the complex salt. The invention relates further to a method and a device for operating the heating device.

### BACKGROUND

To comply with statutory limitations on noxious emissions from motor vehicles it is known how to duct ammonia to an exhaust gas produced by the relevant motor vehicle so that the ammonia will react in a special exhaust-gas catalytic converter with nitrogen oxides in the exhaust gas to produce substances generally recognized as safe. That way of reducing noxious emissions is frequently employed in motor vehicles having diesel combustion engines, particularly in motor trucks. It is further known how to obtain hydrogen from ammonia and duct said hydrogen within the motor vehicle to a fuel cell in order to produce energy, or how to produce energy directly from the ammonia. The ammonia can be obtained from a special medium while the internal-combustion engine is operating. The special medium is, for example, a complex salt which releases the ammonia when the complex salt is heated.

A solid ammonia storage device is known from WO 2006/012903 A2. The solid ammonia storage device includes an ammonia-absorbing salt. The ammonia-absorbing salt is an ionic salt generally describable by the formula M_{A}(NH₃)_{N}X_{Z}. M is one or more anions from alkaline earth metals and/or one or more transition metals, for example Mn, Fe, Cl, Ni, Cu, and/or Zn. X is one or more anions. A is the number of cations per salt molecule. Z is the number of anions per salt molecule and N is a coordination number between 2 and 12. The ammonia storage device is suitable for the automotive industry.

An ammonia storage device for producing energy is known from WO 2005/091418 A2. An electric power generating unit includes an ammonia storage device in the form of a container containing an ammonia-absorbing and ammonia-releasing salt. Means are provided for heating the ammonia storage device. The ammonia is used directly for producing energy or is first converted into hydrogen that is then used for producing energy.

### SUMMARY

A heating device and a method and device for operating the heating device may enable simple heating of a medium from which ammonia can be obtained. According to an embodiment, a heating device for heating a storage device for a complex salt in a motor vehicle, may comprise the storage device for the complex salt, and at least one mass-ducting hollow pipe through which while the motor vehicle is operating a mass flows that heats up while the motor vehicle is operating and which is thermally coupled to the storage device for the complex salt in such a way that the heated mass in the mass-ducting hollow pipe will heat the storage device for the complex salt.

According to a further embodiment, a controlling element for specifying a mass flow of the mass through the mass-ducting hollow pipe may be provided. According to a further embodiment, the mass-ducting hollow pipe may include a bypass pipe and in the case of which the storage device for the complex salt is thermally coupled to the bypass pipe and/or mass-ducting hollow pipe. According to a further embodiment, the mass-ducting hollow pipe may include an exhaust-gas pipe of the motor vehicle. According to a further embodiment, the mass-ducting hollow pipe may include an exhaust-gas feedback pipe. According to a further embodiment, the mass-ducting hollow pipe may include a cooling-water pipe of the motor vehicle. According to a further embodiment, the storage device for the complex salt may be located downstream of one or more exhaust-gas catalytic converters of the motor vehicle.

According to another embodiment, a method for operating a heating device for a motor vehicle comprising a storage device for complex salt and at least one mass-ducting hollow pipe, may comprise the step of flowing a mass through said mass-ducting pipe, said mass heating up while the motor vehicle is operating, wherein the mass is thermally coupled to the storage device for the complex salt, wherein the mass flow of the mass is routed past the storage device for the complex salt in such a way that the thermal energy of the heated mass will at least partially heat the storage device for the complex salt.

According to a further embodiment, a controlling element for specifying a mass flow of the mass through the mass-ducting hollow pipe can be provided. According to a further embodiment, the mass-ducting hollow pipe may include a bypass pipe and in the case of which the storage device for the complex salt is thermally coupled to the bypass pipe and/or mass-ducting hollow pipe. According to a further embodiment, the mass-ducting hollow pipe may include an exhaust-gas pipe of the motor vehicle. According to a further embodiment, the mass-ducting hollow pipe may include an exhaust-gas feedback pipe. According to a further embodiment, the mass-ducting hollow pipe may include a cooling-water pipe of the motor vehicle. According to a further embodiment, the storage device for the complex salt may be located downstream of one or more exhaust-gas catalytic converters of the motor vehicle. According to a further embodiment, a setpoint temperature of the complex salt in the storage device for the complex salt may be determined as a function of a specified need for ammonia mass, a setpoint mass flow of the heated mass may be determined as a function of the determined setpoint temperature of the complex salt, an actuating signal for the controlling element for influencing the mass flow of the heated mass may be determined as a function of the determined setpoint mass flow of the heated mass, and the controlling element for influencing the mass flow of the heated mass may be driven as a function of the determined actuating signal for the controlling element for influencing the mass flow of the heated mass.

According to another embodiment, a device for operating a heating device for a complex salt in a motor vehicle, may comprise a storage device for the complex salt, and at least one mass-ducting hollow pipe through which while the motor vehicle is operating a mass flows that heats up while the motor vehicle is operating and which is thermally coupled to the storage device for the complex salt in such a way that the heated mass in the mass-ducting hollow pipe will heat the storage device for the complex salt, wherein the device is embodied for routing the mass flow of the mass heated while the motor vehicle is operating past the storage device for the complex salt in such a way that the thermal energy of the heated mass will at least partially heat the storage device for the complex salt.

According to a further embodiment, a controlling element for specifying a mass flow of the mass through the mass-ducting hollow pipe may be provided. According to a further embodiment, the mass-ducting hollow pipe may include a bypass pipe and in the case of which the storage device for the complex salt is thermally coupled to the bypass pipe and/or mass-ducting hollow pipe. According to a further embodiment, the mass-ducting hollow pipe may include an exhaust-gas pipe of the motor vehicle. According to a further embodiment, the mass-ducting hollow pipe may include an exhaust-gas feedback pipe. According to a further embodiment, the mass-ducting hollow pipe may include a cooling-water pipe of the motor vehicle. According to a further embodiment, the storage device for the complex salt may be located downstream of one or more exhaust-gas catalytic converters of the motor vehicle.

### BRIEF DESCRIPTION OF THE DRAWINGS

The invention is explained in more detail below with the aid of schematics.

FIG. 1 shows a first embodiment variant of a heating device,

FIG. 2 shows a second embodiment variant of the heating device,

FIG. 3 shows a third embodiment variant of the heating device,

FIG. 4 shows a fourth embodiment variant of the heating device, and

FIG. 5 is a flowchart of a program for operating the heating device.

Elements having the same design or function have been given the same reference letters/numerals in all figures.

### DETAILED DESCRIPTION

According to an embodiment, a heating device serves to heat a storage device for a complex salt in a motor vehicle. The heating device includes the storage device for the complex salt and at least one mass-ducting hollow pipe. A mass flows through the mass-ducting hollow pipe while the motor vehicle is operating. The mass heats up while the motor vehicle is operating. The mass-ducting hollow pipe is thermally coupled to the storage device for the complex salt in such a way that the heated mass in the mass-ducting hollow pipe will heat the storage device for the complex salt.

This enables the thermal energy of the heated mass to be used for heating the storage device without having to expend additional energy for heating the storage device.

The mass is heated through the internal-combustion engine's operation, in particular independently of an electric heating device. The complex salt is preferably one of the salts listed in the documents cited in the introduction relating to the prior art.

According to an embodiment, a controlling element can be provided for setting a mass flow of the mass through the mass-ducting hollow pipe. This enables the storage device's temperature to be set in a simple manner.

According to an embodiment, the mass-ducting hollow pipe may include a bypass pipe. The storage device for the complex salt is thermally coupled to the bypass pipe and/or mass-ducting hollow pipe. This can help to heat the storage device for the complex salt particularly effectively.

According to an embodiment, the mass-ducting hollow pipe may include an exhaust-gas pipe of the motor vehicle. This enables the storage device for the complex salt to be heated in a simple manner with no additional mass-ducting hollow pipe.

According to an embodiment, the mass-ducting hollow pipe may include an exhaust-gas feedback pipe. This enables the storage device for the complex salt to be heated in a simple manner with no additional mass-ducting hollow pipe.

According to an embodiment, the mass-ducting hollow pipe may include a cooling-water pipe of the motor vehicle. This enables the storage device for the complex salt to be heated in a simple manner with no additional mass-ducting hollow pipe.

According to an embodiment, the storage device for the complex salt may be located downstream of one or more exhaust-gas catalytic converters of the motor vehicle. This helps the exhaust-gas catalytic converter(s) quickly reach its/their operating temperature without it being possible for the thermal energy necessary therefor to be taken up by the storage device for the complex salt.

According to another embodiment, in a method and a device for operating the heating device, the mass flow of the mass heated while the motor vehicle is operating is routed past the storage device for the complex salt in such a way that the thermal energy of the heated mass will at least partially heat the storage device for the complex salt.

According to an embodiment, a setpoint temperature of the complex salt in the storage device for the complex salt may be determined as a function of a specified need for ammonia mass. A setpoint mass flow of the heated mass is determined as a function of the determined setpoint temperature of the complex salt. An actuating signal for the controlling element for influencing the mass flow of the heated mass is determined as a function of the determined setpoint mass flow of the heated mass. The controlling element for influencing the mass flow of the heated mass is driven as a function of the determined actuating signal for the controlling element for influencing the mass flow of the heated mass. This helps to obtain preferably as much ammonia from the complex salt as is necessary for reducing noxious emissions and/or producing hydrogen and/or producing energy. The need for ammonia mass can be specified as a function of, for instance, a NOX content in the exhaust gas and/or as a function of the motor vehicle's need for hydrogen or energy.

These embodiments can be applied both to the device and to the method for operating the heating device.

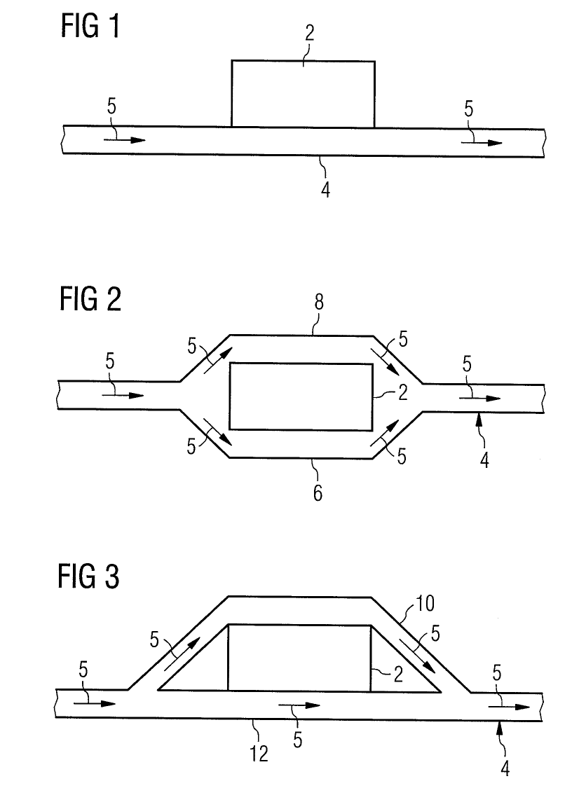

A heating device (FIG. 1) includes a storage device 2 for a complex salt and a mass-ducting hollow pipe 4. The heating device is preferably located in a motor vehicle. The storage device 2 for the complex salt is preferably embodied specifically for storing the complex salt. A mass that heats up while the motor vehicle is operating flows through the mass-ducting hollow pipe 4 while the motor vehicle is operating. The mass is heated in particular through the operation of an internal-combustion engine in the motor vehicle and not by means of an electric heater in the motor vehicle. The mass flows through the mass-ducting hollow pipe 4 in a flow direction 5. The storage device 2 for the complex salt is filled preferably at least partially with the complex salt.

The mass is preferably an exhaust-gas mass of the motor vehicle and/or a cooling-water mass of the motor vehicle. The mass-ducting hollow pipe 4 accordingly includes an exhaust-gas pipe and/or an exhaust-gas feedback pipe or, as the case may be, a cooling-water pipe of the motor vehicle.

The complex salt preferably includes one of the salts disclosed in the publications WO 06/012903 A2 and WO 2005/091418 A2 that were cited in the introduction and whose content is hereby included herein in this regard. Ammonia can be released by heating the complex salt to temperatures between 10 and 700 degrees Celsius depending on the complex salt used and the amount required. Reference is made in terms of the exact production of ammonia from the complex salt to the cited publications whose content is included in this regard. The ammonia can be used for reducing noxious emissions in an exhaust gas from the internal-combustion engine, in particular for reducing nitrogen oxides in the exhaust gas, and/or for producing energy, particularly for producing hydrogen. The hydrogen can be ducted to a fuel cell. Nitrogen oxides are reduced through the nitrogen oxides' reacting with the ammonia in an exhaust-gas catalytic converter of the motor vehicle, in particular in an SCR catalytic converter.

The mass-ducting hollow pipe 4 is thermally coupled to the storage device 2 for the complex salt in such a way that the heated mass in the mass-ducting hollow pipe 4 can transfer the thermal energy to the complex salt via a side of the mass-ducting hollow pipe 4 and a side of the storage device 2 for the complex salt.

Between the mass-ducting hollow pipe 4 and/or bypass pipe 10 (FIG. 3) and the storage device 2 for the complex salt it is further possible to insert a medium, preferably one by means of which the transfer of heat will be improved, for example a heat-conducting paste and/or a solid body that will conduct the heat especially well.

The transfer of heat from the mass-ducting hollow pipe 4 to the storage device 2 for the complex salt can be improved by coupling at least a first branch 6 of the mass-ducting hollow pipe 4 and a second branch 8 of the mass-ducting hollow pipe 4 to the storage device 2 for the complex salt and routing them around the storage device 2 for the complex salt (FIG. 2).

A bypass pipe 10 of the mass-ducting hollow pipe 4 can alternatively or additionally be coupled to the storage device 2 for the complex salt and routed past the storage device 2 for the complex salt (FIG. 3).

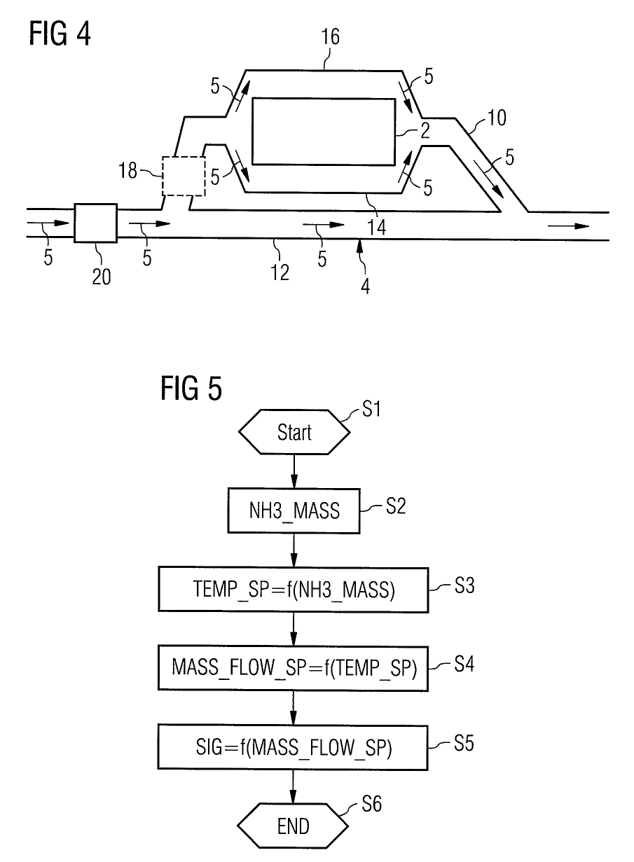

A further advantageous embodiment variant of the heating device (FIG. 4) provides for the mass-ducting hollow pipe 4 to have the bypass pipe 10 and for the bypass pipe 10 to have a first branch 14 of the bypass pipe 10 and a second branch 16 of the bypass pipe 10. The first and second branch 14, 16 of the bypass pipe 10 are thermally coupled to the storage device 2 for the complex salt in such a way that the thermal energy can flow from the two branches to the storage device 2 for the complex salt. Preferably provided upstream of the storage device 2 for the complex salt is a controlling element 18, for example a valve, by means of which a mass flow of the heated mass through the two branches of the bypass pipe 10 and/or mass-ducting hollow pipe 4 can be specified. The controlling element 18 can also be located in the bypass pipe 10 if the bypass pipe 10 does not have the two branches of the bypass pipe 10.

If the mass-ducting hollow pipe 4 is the internal-combustion engine's exhaust-gas pipe, then the heating device will be located preferably downstream of one or more exhaust-gas catalytic converters. This helps the heat in the exhaust gas to be used first for heating the catalytic converters, so they will be operable as quickly as possible, and only then used for heating the storage device 2 for the complex salt.

A program for operating the heating device is preferably stored in a storage medium of a control device of the motor vehicle (FIG. 5). The control device can be referred to also as a device for operating the heating device. The program serves to heat the complex salt in the storage device 2 for the complex salt in such a way that preferably a needed specified ammonia mass will be available. A need for ammonia mass NH3_MASS can be specified as a function of, for instance, a nitrogen-oxide content in the exhaust gas and/or as a function of a need for hydrogen for a fuel cell in the motor vehicle and/or as a function of the motor vehicle's need for energy. The program is launched preferably at a step S1 at which variables may be initialized.

The need for ammonia mass NH3_MASS is determined at a step S2. The need for ammonia mass NH3_MASS can be determined based on, for example, a need-for-ammonia-mass characteristic and/or a model calculation. The need-for-ammonia-mass characteristic, possibly further characteristics, the model calculation, and possibly further model calculations can be recorded and/or determined at an engine test bed, for example.

A setpoint temperature TEMP_SP of the complex salt is determined at a step S3 as a function of the determined need for ammonia mass NH3_MASS. The setpoint temperature TEMP_SP can be obtained based on, for instance, a setpoint-temperature characteristic and/or a further model calculation.

A setpoint mass flow MASS_FLOW_SP of the heated mass through the mass-ducting hollow pipe 4 is determined at a step S4 as a function of the setpoint temperature TEMP_SP of the complex salt. The setpoint mass flow MASS_FLOW_SP of the heated mass can be determined based on, for example, a setpoint-mass-flow characteristic and/or a further model calculation.

An actuating signal SIG is determined at a step S5 as a function of the setpoint mass flow MASS_FLOW_SP of the heated mass. The controlling element 18 can further be driven at step S5 as a function of the actuating signal SIG.

The invention is not restricted to the exemplary embodiments described. For example the mass-ducting hollow pipe 4 can have any number of branches and/or be routed in any way past the storage device 2 for the complex salt such that the complex salt will be heated. For example the mass-ducting hollow pipe 4 and/or a branch of the mass-ducting hollow pipe 4 can be routed through the storage device 2 for the complex salt. The control device for operating the heating device can further be integrated in an engine control of the motor vehicle. The program for operating the heating device can further be implemented in another program.

What is claimed is:

1. A heating device for heating a storage device for a complex salt in a motor vehicle, comprising:
the storage device for the complex salt, and
at least one mass-ducting hollow pipe through which while the motor vehicle is operating a mass flows that heats up while the motor vehicle is operating and which is thermally coupled to the storage device for the complex salt in such a way that the heated mass in the mass-ducting hollow pipe will heat the storage device for the complex salt.

2. The heating device according to claim 1, wherein a controlling element for specifying a mass flow of the mass through the mass-ducting hollow pipe is provided.

3. The heating device according to claim 1, wherein the mass-ducting hollow pipe includes a bypass pipe and in the case of which the storage device for the complex salt is thermally coupled to the bypass pipe and/or mass-ducting hollow pipe.

4. The heating device according to claim 1, wherein the mass-ducting hollow pipe includes an exhaust-gas pipe of the motor vehicle.

5. The heating device according to claim 1, wherein the mass-ducting hollow pipe includes an exhaust-gas feedback pipe.

6. The heating device according to claim 1, wherein the mass-ducting hollow pipe includes a cooling-water pipe of the motor vehicle.

7. The heating device according to claim 3, wherein the storage device for the complex salt is located downstream of one or more exhaust-gas catalytic converters of the motor vehicle.

8. A method for operating a heating device for a motor vehicle comprising a storage device for complex salt and at least one mass-ducting hollow pipe, the method comprising the step of:
flowing a mass through said mass-ducting pipe, said mass heating up while the motor vehicle is operating, wherein the mass is thermally coupled to the storage device for the complex salt, wherein the mass flow of the mass is routed past the storage device for the complex salt in such a way that the thermal energy of the heated mass will at least partially heat the storage device for the complex salt.

9. The method according to claim 8, wherein a controlling element for specifying a mass flow of the mass through the mass-ducting hollow pipe is provided.

10. The method according to claim 8, wherein the mass-ducting hollow pipe includes a bypass pipe and in the case of which the storage device for the complex salt is thermally coupled to the bypass pipe and/or mass-ducting hollow pipe.

11. The method according to claim 8, wherein the mass-ducting hollow pipe includes an exhaust-gas pipe of the motor vehicle.

12. The method according to claim 8, wherein the mass-ducting hollow pipe includes an exhaust-gas feedback pipe.

13. The method according to claim 8, wherein the mass-ducting hollow pipe includes a cooling-water pipe of the motor vehicle.

14. The method according to claim 10, wherein the storage device for the complex salt is located downstream of one or more exhaust-gas catalytic converters of the motor vehicle.

15. The method according to claim 8, wherein
a setpoint temperature of the complex salt in the storage device for the complex salt is determined as a function of a specified need for ammonia mass,
a setpoint mass flow of the heated mass is determined as a function of the determined setpoint temperature of the complex salt,
an actuating signal for the controlling element for influencing the mass flow of the heated mass is determined as a function of the determined setpoint mass flow of the heated mass, and
the controlling element for influencing the mass flow of the heated mass is driven as a function of the determined actuating signal for the controlling element for influencing the mass flow of the heated mass.

16. A device for operating a heating device for a complex salt in a motor vehicle, comprising:
a storage device for the complex salt, and
at least one mass-ducting hollow pipe through which while the motor vehicle is operating a mass flows that heats up while the motor vehicle is operating and which is thermally coupled to the storage device for the complex salt in such a way that the heated mass in the mass-ducting hollow pipe will heat the storage device for the complex salt, wherein the device is embodied for routing the mass flow of the mass heated while the motor vehicle is operating past the storage device for the complex salt in such a way that the thermal energy of the heated mass will at least partially heat the storage device for the complex salt.

17. The device according to claim 16, wherein a controlling element for specifying a mass flow of the mass through the mass-ducting hollow pipe is provided.

18. The device according to claim 16, wherein the mass-ducting hollow pipe includes a bypass pipe and in the case of which the storage device for the complex salt is thermally coupled to the bypass pipe and/or mass-ducting hollow pipe.

19. The device according to claim 16, wherein the mass-ducting hollow pipe includes an exhaust-gas pipe of the motor vehicle.

20. The device according to claim 16, wherein the mass-ducting hollow pipe includes an exhaust-gas feedback pipe.

21. The device according to claim 16, wherein the mass-ducting hollow pipe includes a cooling-water pipe of the motor vehicle.

22. The device according to claim 18, wherein the storage device for the complex salt is located downstream of one or more exhaust-gas catalytic converters of the motor vehicle.
